(19) United States
(12) Patent Application Publication
(10) Pub. No.: US 2024/0179168 A1
(43) Pub. Date: May 30, 2024

(54) NETWORK ACCESS ANOMALY DETECTION AND MITIGATION

(71) Applicant: Juniper Networks, Inc., Sunnyvale, CA (US)

(72) Inventors: Natarajan Manthiramoorthy, Fremont, CA (US); Raja Rao Tadimeti, San Jose, CA (US); Madhava Rao Cheethirala, San Jose, CA (US)

(21) Appl. No.: 18/551,981

(22) PCT Filed: Jun. 29, 2022
(86) PCT No.: PCT/US2022/073263

§ 371 Date: Sep. 22, 2023

Related U.S. Application Data
(60) Provisional application No. 63/216,055, filed on Jun. 29, 2021.

(51) Int. Cl. H04L 9/40

(52) U.S. Cl. CPC H04L 63/1425; H04L 63/0876

(57) ABSTRACT

Techniques are described for network access anomaly detection and mitigation that improves network security for wired and/or wireless devices. An example method includes receiving a network access request for a client device to access a network; obtaining fingerprinting information of the client device; determining whether the client device is a new client device requesting access to the network; in response to determining that the client device is not a new client device requesting access to the network, determining whether the fingerprinting information of the client device has an anomaly to previously obtained fingerprinting information of an authorized client device; and executing, in response to determining that the fingerprinting information of the client device has an anomaly to previously obtained fingerprinting information of the authorized client device, an access policy to manage access to the network by the client device associated with the network access request.

This application claims the priority benefit of U.S. Provisional Patent Application No. 63/216,055, entitled “METHODS FOR NETWORK ACCESS ANOMALY DETECTION AND MITIGATION AND DEVICES THEREOF,” and filed 29 Jun. 2021, the entire content of each application is incorporated herein by reference.

### TECHNICAL FIELD

The disclosure relates generally to computer networks and, more specifically, to managing access to computer networks.

### BACKGROUND

Commercial premises or sites, such as offices, hospitals, airports, stadiums, or retail outlets, often install complex wireless network systems, including a network of wireless access points (APs), throughout the premises to provide wireless network services to one or more client devices (or simply, “clients”). APs are physical, electronic devices that enable other devices to wirelessly connect to a wired network using various wireless networking protocols and technologies, such as wireless local area networking protocols conforming to one or more of the IEEE 802.11 standards (i.e., “WiFi”), Bluetooth/Bluetooth Low Energy (BLE), mesh networking protocols such as ZigBee or other wireless networking technologies.

Many different types of client devices, such as laptop computers, smartphones, tablets, wearable devices, appliances, and Internet of Things (IOT) devices, incorporate wireless communication technology and can be configured to connect to wireless access points when the device is in range of a compatible AP. In order to gain access to a wireless network, a client device may first need to authenticate to the AP. Authentication may occur via a handshake exchange between the client device, the AP, and an Authentication, Authorization, and Accounting (AAA) server controlling access at the AP. Client devices in enterprise networks can be authenticated for network access via Institute of Electrical and Electronics Engineers (IEEE) 802.1X Port-based Network Access Control (PNAC) or Media Access Control Authentication Bypass (MAB).

### SUMMARY

In general, this disclosure describes one or more techniques for network access anomaly detection and mitigation that improves network security for wired and/or wireless devices that use MAB and/or 802.1X authentication. In some examples, network access control (NAC) systems may provide a way of authenticating client devices to access networks, such as branch or campus enterprise networks. NAC systems may identify client devices and provide client devices with the appropriate authorizations or access policies based on their identities, e.g., by assigning the client devices to certain virtual local area networks (VLANs), applying certain access control lists (ACLs), directing the client devices to certain registration portals, or the like. NAC systems may identify client devices by analyzing network behavior of the client devices, referred to as fingerprinting. Identification of client devices and/or NAS devices may be performed based on media access control (MAC) addresses, DHCP options used to request IP addresses, link layer discovery protocol (LLDP) packets, Hypertext Transfer Protocol (HTTP) user agent information, location information, DNS information, and/or device type and operating system information.

The techniques of this disclosure provide one or more technical advantages and practical applications. For example, by obtaining fingerprinting information of client devices and authenticating client devices based on the fingerprinting information, the NAC system may detect and mitigate unauthorized client devices from attempting to gain access to the network, such as by spoofing a MAC address of authorized devices.

In one example, this disclosure describes a method includes receiving a network access request for a client device to access a network; obtaining fingerprinting information of the client device associated with the network access request, wherein the fingerprinting information comprises information specifying network behavior and location information of the client device associated with the network access request; determining whether the client device associated with the network access request is a new client device requesting access to the network; in response to determining that the client device associated with the network access request is not a new client device requesting access to the network, determining whether the fingerprinting information of the client device associated with the network access request has an anomaly to previously obtained fingerprinting information of an authorized client device, wherein the previously obtained fingerprinting information of the authorized client device comprises information specifying network behavior and location information of the authorized client device; and executing, in response to determining that the fingerprinting information of the client device associated with the network access request has an anomaly to previously obtained fingerprinting information of the authorized client device, an access policy to manage access to the network by the client device associated with the network access request.

In another example, this disclosure describes a NAC system includes a memory; one or more processors in communication with the memory, the one or more processors configured to: receive a network access request for a client device to access a network; obtain fingerprinting information of the client device associated with the network access request, wherein the fingerprinting information comprises information specifying network behavior and location information of the client device associated with the network access request; determine whether the client device associated with the network access request is a new client device requesting access to the network; in response to determining the client device associated with the network access request is not a new client device requesting access to the network, determine whether the fingerprinting information of the client device associated with the network access request has an anomaly to previously obtained fingerprinting information of an authorized client device, wherein the previously obtained fingerprinting information of the authorized client device comprises information specifying network behavior and location information of the authorized client device; and execute, in response to determining that the fingerprinting information of the client device associated with the network access request has an anomaly to previously obtained fingerprinting information of an authorized client device, an access policy to manage access to the network by the client device associated with the network access request.

In another example, this disclosure describes a non-transitory computer readable medium includes obtain fingerprinting information of the client device associated with the network access request, wherein the fingerprinting information comprises information specifying network behavior and location information of the client device associated with the network access request; determine whether the client device associated with the network access request is a new client device requesting access to the network; in response to determining the client device associated with the network access request is not a new client device requesting access to the network, determine whether the fingerprinting information of the client device associated with the network access request has an anomaly to previously obtained fingerprinting information of an authorized client device, wherein the previously fingerprinting information of the authorized client device comprises information specifying network behavior and location information of the authorized client device; and execute, in response to determining that the fingerprinting information of the client device associated with the network access request has an anomaly to previously obtained fingerprinting information of an authorized client device, an access policy to manage access to the network by the client device associated with the network access request.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1A is a block diagram of an example network system including a network management system and network access control systems, in accordance with one or more techniques of the disclosure.

FIG. 1B is a block diagram illustrating further example details of the network system of FIG. 1A.

FIG. 2 is a block diagram of an example network access control system, in accordance with one or more techniques of this disclosure.

FIG. 3 is a block diagram of an example network management system, in accordance with one or more techniques of the disclosure.

FIG. 4 is a block diagram of an example access point device, in accordance with one or more techniques of this disclosure.

FIG. 5 is a block diagram of an example edge device, in accordance with one or more techniques of this disclosure.

FIG. 6 is a flow chart illustrating an example operation to obtain fingerprinting information of client devices and use the fingerprinting information to authenticate client devices requesting to access the network, in accordance with one or more techniques of this disclosure.

### DETAILED DESCRIPTION

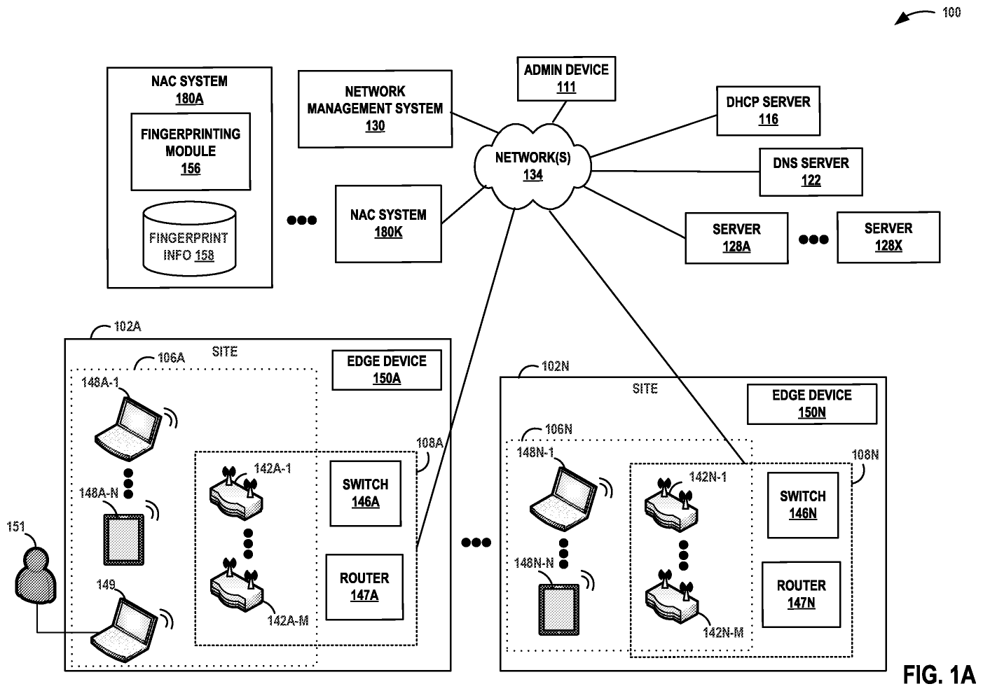

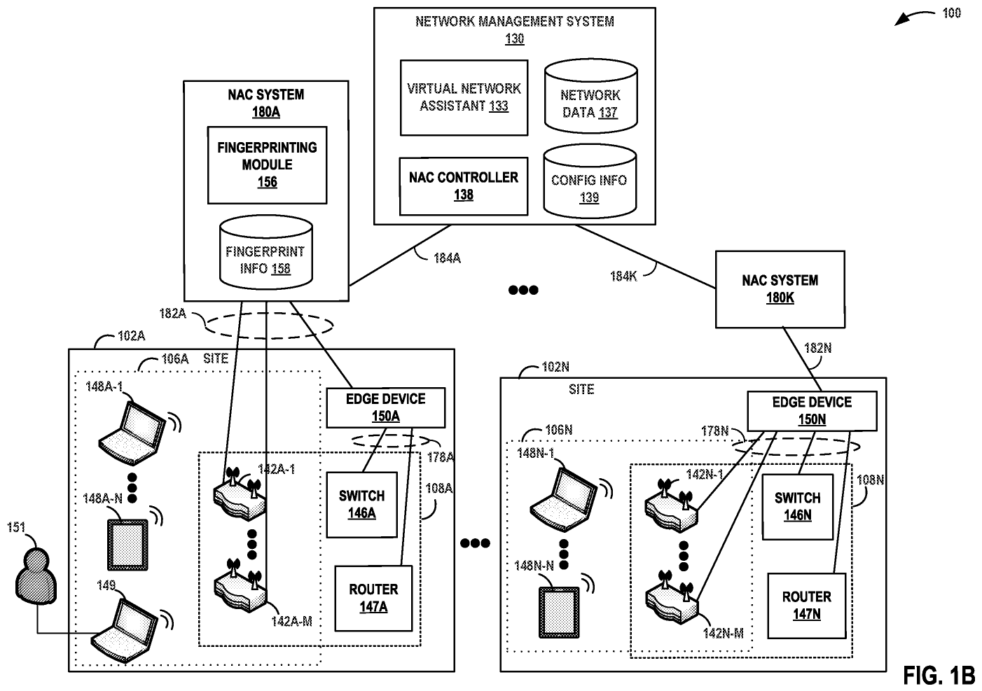

FIG. 1A is a block diagram of an example network system 100 including network access control (NAC) systems 180A-180K and network management system (NMS) 130, in accordance with one or more techniques of this disclosure. Example network system 100 includes a plurality sites 102A-102N at which a network service provider manages one or more wireless networks 106A-106N, respectively. Although in FIG. 1A each site 102A-102N is shown as including a single wireless network 106A-106N, respectively, in some examples, each site 102A-102N may include multiple wireless networks, and the disclosure is not limited in this respect.

Each site 102A-102N includes a plurality of network access server (NAS) devices 108A-108N, such as access points (APs) 142, switches 146, and routers 147. NAS devices may include any network infrastructure devices capable of authenticating and authorizing client devices to access an enterprise network. For example, site 102A includes NAS devices 108A, such as a plurality of APs 142A-1 through 142A-M, a switch 146A, and a router 147A. Similarly, site 102N includes NAS devices 108N a plurality of APs 142N-1 through 142N-M, a switch 146N, and a router 147N. Each AP 142 may be any type of wireless access point, including, but not limited to, a commercial or enterprise AP, a router, or any other device that is connected to a wired network and is capable of providing wireless network access to client devices within the site. In some examples, each of APs 142A-1 through 142A-M at site 102A may be connected to one or both of switch 146A and router 147A. Similarly, each of APs 142N-1 through 142N-M at site 102N may be connected to one or both of switch 146N and router 147N.

Each site 102A-102N also includes a plurality of client devices, otherwise known as user equipment devices (UEs), referred to generally as UEs or client devices 148, representing various wired and/or wireless-enabled devices within each site. For example, a plurality of UEs 148A-1 through 148A-K are currently located at site 102A. Similarly, a plurality of UEs 148N-1 through 148N-K are currently located at site 102N. Each UE 148 may be any type of wireless client device, including, but not limited to, a mobile device such as a smart phone, tablet or laptop computer, a personal digital assistant (PDA), a wireless terminal, a smart watch, smart ring, or other wearable device. UEs 148 may also include wired client-side devices, e.g., IoT devices such as printers, projectors, security devices, environmental sensors, or any other device connected to the wired network and configured to communicate over one or more wireless networks 106.

In order to provide wireless network services to UEs 148 and/or communicate over the wireless networks 106, APs 142 and the other wired client-side devices at sites 102 are connected, either directly or indirectly, to one or more network devices (e.g., switches, routers, gateways, or the like) via physical cables, e.g., Ethernet cables. Although illustrated in FIG. 1A as if each site 102 includes a single switch and a single router, in other examples, each site 102 may include more or fewer switches and/or routers. In addition, two or more switches at a site may be connected to each other and/or connected to two or more routers, e.g., via a mesh or partial mesh topology in a hub-and-spoke architecture. In some examples, interconnected switches 146 and routers 147 comprise wired local area networks (LANs) at sites 102 hosting wireless networks 106.

Example network system 100 also includes various networking components for providing networking services within the wired network including, as examples, NAC systems 180 including or providing access to Authentication, Authorization and Accounting (AAA) servers for authenticating users and/or UEs 148, a Dynamic Host Configuration Protocol (DHCP) server 116 for dynamically assigning network addresses (e.g., IP addresses) to UEs 148 upon authentication, a Domain Name System (DNS) server 122 for resolving domain names into network addresses, a plurality of servers 128A-128X (collectively “servers 128”) (e.g., web servers, databases servers, file servers and the like), and NMS 130. As shown in FIG. 1A, the various devices and systems of network 100 are coupled together via one or more network(s) 134, e.g., the Internet and/or an enterprise intranet.

In the example of FIG. 1A, NMS 130 is a cloud-based computing platform that manages wireless networks 106A-106N at one or more of sites 102A-102N. As further described herein, NMS 130 provides an integrated suite of management tools and implements various techniques of this disclosure. In general, NMS 130 may provide a cloud-based platform for wireless network data acquisition, monitoring, activity logging, reporting, predictive analytics, network anomaly identification, and alert generation. In some examples, NMS 130 outputs notifications, such as alerts, alarms, graphical indicators on dashboards, log messages, text/SMS messages, email messages, and the like, and/or recommendations regarding wireless network issues to a site or network administrator (“admin”) interacting with and/or operating admin device 111. Additionally, in some examples, NMS 130 operates in response to configuration input received from the administrator interacting with and/or operating admin device 111.

The administrator and admin device 111 may comprise IT personnel and an administrator computing device associated with one or more of sites 102. Admin device 111 may be implemented as any suitable device for presenting output and/or accepting user input. For instance, admin device 111 may include a display. Admin device 111 may be a computing system, such as a mobile or non-mobile computing device operated by a user and/or by the administrator. Admin device 111 may, for example, represent a workstation, a laptop or notebook computer, a desktop computer, a tablet computer, or any other computing device that may be operated by a user and/or present a user interface in accordance with one or more aspects of the present disclosure. Admin device 111 may be physically separate from and/or in a different location than NMS 130 such that admin device 111 may communicate with NMS 130 via network 134 or other means of communication.

In some examples, one or more of NAS devices 108, e.g., APs 142, switches 146, and routers 147, may connect to edge devices 150A-150N via physical cables, e.g., Ethernet cables. Edge devices 150 comprise cloud-managed, wireless local area network (LAN) controllers. Each of edge devices 150 may comprise an on-premises device at a site 102 that is in communication with NMS 130 to extend certain microservices from NMS 130 to the on-premises NAS devices 108 while using NMS 130 and its distributed software architecture for scalable and resilient operations, management, troubleshooting, and analytics.

Each one of the network devices of network system 100, e.g., NAC systems 180, servers 116, 122 and/or 128, APs 142, switches 146, routers 147, UEs 148, edge devices 150, and any other servers or devices attached to or forming part of network system 100, may include a system log or an error log module wherein each one of these network devices records the status of the network device including normal operational status and error conditions. Throughout this disclosure, one or more of the network devices of network system 100, e.g., servers 116, 122 and/or 128, APs 142, switches 146, routers 147, and UEs 148, may be considered “third-party” network devices when owned by and/or associated with a different entity than NMS 130 such that NMS 130 does not directly receive, collect, or otherwise have access to the recorded status and other data of the third-party network devices. In some examples, edge devices 150 may provide a proxy through which the recorded status and other data of the third-party network devices may be reported to NMS 130.

In the example of FIG. 1A, each of NAC systems 180 comprises a cloud-based network access control service at multiple, geographically distributed points of presence. Typically, network access control functionality is offered by on-premises appliances that are limited by processing power and memory as well as maintenance and upgrade issues. Offering cloud-based network access control services avoids the limitations and improves network administration. A centralized, cloud-based deployment of network access control, however, introduces issues with latency and failures that may block client devices from network access.

In accordance with the disclosed techniques, NAC systems 180 provide multiple points of presence or NAC clouds at several geographic regions. NMS 130 is configured to manage NAC configuration, including access policies for enterprise networks, and push the appropriate NAC configuration data or files to the respective NAC systems 180A-180K. In this way, NAC systems 180 provide the same benefits as a centralized, cloud-based network access control service with lower latency and high availability.

NAC systems 180 provide a way of authenticating client devices 148 to access wireless networks 106, such as branch or campus enterprise networks. NAC systems 180 may each include or provide access to an Authentication, Authorization, and Accounting (AAA) server, e.g., a RADIUS server, to authenticate client devices 148 prior to providing access to the enterprise network via the NAS devices 108. In some examples, NAC systems 180 may enable certificate-based authentication of client devices or enable interaction with cloud directory services to authenticate the client devices.

NAC systems 180 may identify client devices 148 and provide client devices 148 with the appropriate authorizations or access policies based on their identities, e.g., by assigning the client devices to certain virtual local area networks (VLANs), applying certain access control lists (ACLs), directing the client devices to certain registration portals, or the like. NAC systems 180 may identify client devices 148 by analyzing network behavior of the client devices, referred to as fingerprinting. Identification of client devices and/or NAS devices may be performed based on media access control (MAC) addresses, DHCP options used to request IP addresses, link layer discovery protocol (LLDP) packets, Hypertext Transfer Protocol (HTTP) user agent information, location information, DNS information, and/or device type and operating system information.

Client devices 148 may include multiple different categories of devices with respect to a given enterprise, such as trusted enterprise devices, bring-your-own-device (BYOD) devices, IoT devices, and guest devices. NAC system 180 may be configured to subject each of the different categories of devices to different types of tracking, different types of authorization, and different levels of access privileges. In some examples, after a client device gains access to the enterprise network, NAC systems 180 may monitor activities of the client device to identify security concerns and, in response, re-assign the client device to a quarantine VLAN or another less privileged VLAN to restrict access of the client device.

NMS 130 is configured to operate according to an artificial intelligence/machine-learning-based computing platform providing comprehensive automation, insight, and assurance (WiFi Assurance, Wired Assurance and WAN assurance) spanning from “client,” e.g., client devices 148 connected to wireless networks 106 and wired local area networks (LANs) at sites 102 to “cloud,” e.g., cloud-based application services that may be hosted by computing resources within data centers.

As described herein, NMS 130 provides an integrated suite of management tools and implements various techniques of this disclosure. In general, NMS 130 may provide a cloud-based platform for wireless network data acquisition, monitoring, activity logging, reporting, predictive analytics, network anomaly identification, and alert generation. For example, NMS 130 may be configured to proactively monitor and adaptively configure network 100 so as to provide self-driving capabilities.

In some examples, AI-driven NMS 130 also provides configuration management, monitoring and automated oversight of software defined wide-area networks (SD-WANs), which operate as an intermediate network communicatively coupling wireless networks 106 and wired LANs at sites 102 to data centers and application services. In general, SD-WANs provide seamless, secure, traffic-engineered connectivity between “spoke” routers (e.g., routers 147) of the wired LANs hosting wireless networks 106, such as branch or campus enterprise networks, to “hub” routers further up the cloud stack toward the cloud-based application services. SD-WANs often operate and manage an overlay network on an underlying physical Wide-Area Network (WAN), which provides connectivity to geographically separate customer networks. In other words, SD-WANs extend Software-Defined Networking (SDN) capabilities to a WAN and allow network(s) to decouple underlying physical network infrastructure from virtualized network infrastructure and applications such that the networks may be configured and managed in a flexible and scalable manner.

In some examples, AI-driven NMS 130 may enable intent-based configuration and management of network system 100, including enabling construction, presentation, and execution of intent-driven workflows for configuring and managing devices associated with wireless networks 106, wired LAN networks, and/or SD-WANs. For example, declarative requirements express a desired configuration of network components without specifying an exact native device configuration and control flow. By utilizing declarative requirements, what should be accomplished may be specified rather than how it should be accomplished. Declarative requirements may be contrasted with imperative instructions that describe the exact device configuration syntax and control flow to achieve the configuration. By utilizing declarative requirements rather than imperative instructions, a user and/or user system is relieved of the burden of determining the exact device configurations required to achieve a desired result of the user/system. For example, it is often difficult and burdensome to specify and manage exact imperative instructions to configure each device of a network when various different types of devices from different vendors are utilized. The types and kinds of devices of the network may dynamically change as new devices are added and device failures occur. Managing various different types of devices from different vendors with different configuration protocols, syntax, and software versions to configure a cohesive network of devices is often difficult to achieve. Thus, by only requiring a user/system to specify declarative requirements that specify a desired result applicable across various different types of devices, management and configuration of the network devices becomes more efficient. Further example details and techniques of an intent-based network management system are described in U.S. Pat. No. 10,756,983, entitled “Intent-based Analytics,” and U.S. Pat. No. 10,992,543, entitled “Automatically generating an intent-based network model of an existing computer network,” each of which is hereby incorporated by reference.

Although the techniques of the present disclosure are described in this example as performed by NAC systems 180 and/or NMS 130, techniques described herein may be performed by any other computing device(s), system(s), and/or server(s), and that the disclosure is not limited in this respect. For example, one or more computing device(s) configured to execute the functionality of the techniques of this disclosure may reside in a dedicated server or be included in any other server in addition to or other than NAC systems 180 or NMS 130, or may be distributed throughout network 100, and may or may not form a part of NAS systems 180 or NMS 130.

Typically, client devices in enterprise networks can be authenticated for network access via Institute of Electrical and Electronics Engineers (IEEE) 802.1X Port-based Network Access Control (PNAC). For example, a client device that supports 802.1X may provide credentials (e.g., username/password or digital certificate) to an authenticator (e.g., a switch or access point), which encapsulates the message and forwards the message to an authentication server. The authentication server may determine whether the credentials are valid, and in response to determining the credentials are valid, the authenticator may permit the client device to access the network. Client devices that do not support 802.1X (e.g., printers, projectors, etc.) may be authenticated for network access via Media Access Control Authentication Bypass (MAB). MAB uses port-based access control by using a MAC address of the client device. For example, a switch or access point may learn the MAC address of the client device and forwards the learned MAC address to an authentication server. The authentication server may determine whether the MAC address of the client device is valid, and in response to determining that the MAC address is valid, the switch or access point may permit the client device to access the network. However, such protocol options are vulnerable to spoofing. For example, unauthorized client devices may gain access to the network by spoofing a MAC address of an access point or an authorized client device.

In accordance with the techniques described in this disclosure, NAC systems 180 may provide network access anomaly detection and mitigation that improves network security for wired and/or wireless devices that use MAB and/or 802.1X authentication. In this example, NAC systems 180 may include fingerprinting module 156 configured to obtain fingerprinting information of client devices and use the fingerprinting information to authenticate client devices requesting to access the network.

As one example, NAC system 108A may receive a request (referred to herein as “network access request” or “network admission request”) to access network(s) 134 from client device 148A-1 via at least one of NAS devices 108 (e.g., APs 142, switch 146A, router 147A). In response to receiving the network access request, fingerprinting module 156 of NAC system 108A may obtain fingerprinting information of client device 148A-1. As described above, fingerprinting information may include information specifying network behavior and location information of the client device associated with a network access request. As specific examples, fingerprinting information may include DHCP options used to request IP addresses, link layer discovery protocol (LLDP) packets, Hypertext Transfer Protocol (HTTP) user agent information, location information, and/or device type and operating system information. If client device 148A-1 is a new client device requesting access to network(s) 134 (e.g., MAC address of client device 148A-1 is not recognized), fingerprinting module 156 may store the fingerprinting information of client device 148A-1 mapped to a MAC address of client device 148A-1 in a database (illustrated in FIG. 1A as “fingerprint information 158”). The information stored in fingerprint information 158 may represent the fingerprinting information of authorized client devices.

Fingerprinting module 156 may use fingerprinting information stored in fingerprint information 158 to authenticate client devices requesting to access the network. For example, client device 149 of an unauthorized user 151 may spoof a MAC address of client device 148A-1 and sends a network access request to gain access to network(s) 134. NAC system 108A may receive a network access request for client device 149 that has the same MAC address as client device 148A-1. In this example, fingerprinting module 156 may determine that client device 149 is not a new client device (e.g., has a recognized MAC address), and in response, determines whether there is an anomaly between the fingerprinting information of client device 149 and the previously obtained fingerprinting information of client device 148A-1 (e.g., the information stored in fingerprint information 158). For example, fingerprinting module 156 may obtain the fingerprinting information of client device 149, perform a lookup of the fingerprinting information of client device 149 against the information stored in fingerprint information 158, and determine whether the fingerprinting information of client device 149 matches the fingerprinting information of client device 148A-1 stored in fingerprint information 158.

Based on determining that the fingerprinting information of the client device associated with the subsequent network access request has an anomaly (e.g., does not match) to the information stored in fingerprint information 158, fingerprinting module 156 may execute an access policy to manage the access to network(s) 134. For example, the administrator may configure an access policy to deny an unauthorized client device with access to network(s) 134 if fingerprinting information of client device 149 has an anomaly to the information stored in fingerprint information 158 or quarantine client device 149 to a quarantine VLAN or another less privileged VLAN to restrict access of client device 149.

In some examples, fingerprinting module 156 may generate and send a notification to the administrator based on the implemented access policy. For instance, fingerprinting module 156 may generate and send a notification if fingerprinting module 156 implements an access policy to deny or quarantine the unauthorized client device's access to the network. In some examples, the notification may include an indication of a severity level of the unauthorized client device's access to the network.

FIG. 1B is a block diagram illustrating further example details of the network system of FIG. 1A. In this example, FIG. 1B illustrates logical connections 178A-178N, 182A-182N, and 184A-184K, between NAS devices 108 at sites 102, NAC systems 180, and NMS 130. In addition, FIG. 1B illustrates NMS 130 configured to operate according to an AI-based computing platform to provide configuration and management of one or more of NAC systems 180 and NAS devices 108 at sites 102 via the logical connections.

In operation, NMS 130 observes, collects and/or receives network data 137, which may take the form of data extracted from messages, counters, and statistics, for example, from one or more of APs 142, switches 146, routers 147, edge devices 150, NAC systems 180, and/or other nodes within network 134. NMS 130 provides a management plane for network 100, including management of enterprise-specific configuration information 139 for one or more of NAS devices 108 at sites 102 and NAC systems 180. Each of the one or more NAS devices 108 and each of NAC systems 180 may have a secure connection with NMS 130, e.g., a RadSec (RADIUS over Transport Layer Security (TLS)) tunnel or another encrypted tunnel. Each of the NAS devices 108 and NAC systems 180 may download the appropriate enterprise-specific configuration information 139 from NMS 130 and enforce the configuration. In some scenarios, one or more of the NAS devices 108 may be a third-party device or otherwise not support establishment of a secure connection directly with NMS 130. In these scenarios, edge devices 150 may provide proxies through which the NAS devices 108 may connect to NMS 130.

In accordance with one specific implementation, a computing device is part of NMS 130. In accordance with other implementations, NMS 130 may comprise one or more computing devices, dedicated servers, virtual machines, containers, services, or other forms of environments for performing the techniques described herein. Similarly, computational resources and components implementing VNA 133 may be part of the NMS 130, may execute on other servers or execution environments, or may be distributed to nodes within network 134 (e.g., routers, switches, controllers, gateways, and the like).

In some examples, NMS 130 monitors network data 137, e.g., one or more service level expectation (SLE) metrics, received from each site 102A-102N, and manages network resources, such as the one or more of APs 142, switches 146, routers 147, and edge devices 150 at each site, to deliver a high-quality wireless experience to end users, IoT devices and clients at the site. In other examples, NMS 130 monitors network data 137 received from NAC systems 180 and manages enterprise-specific configuration information 139 for NAC systems 180 to enable unconstrained network access control services for client devices 148 at sites 102 with low latency and high availability.

As illustrated in FIG. 1B, NMS 130 may include a virtual network assistant (VNA) 133 that implements an event processing platform for providing real-time insights and simplified troubleshooting for IT operations, and that automatically takes corrective action or provides recommendations to proactively address network issues. VNA 133 may, for example, include an event processing platform configured to process hundreds or thousands of concurrent streams of network data 137 from sensors and/or agents associated with APs 142, switches 146, routers 147, edge devices 150, NAC systems 180, and/or other nodes within network 134. For example, VNA 133 of NMS 130 may include an underlying analytics and network error identification engine and alerting system in accordance with various examples described herein. The underlying analytics engine of VNA 133 may apply historical data and models to the inbound event streams to compute assertions, such as identified anomalies or predicted occurrences of events constituting network error conditions. Further, VNA 133 may provide real-time alerting and reporting to notify a site or network administrator via admin device 111 of any predicted events, anomalies, trends, and may perform root cause analysis and automated or assisted error remediation. In some examples, VNA 133 of NMS 130 may apply machine learning techniques to identify the root cause of error conditions detected or predicted from the streams of network data 137. If the root cause may be automatically resolved, VNA 133 may invoke one or more corrective actions to correct the root cause of the error condition, thus automatically improving the underlying SLE metrics and also automatically improving the user experience.

Further example details of operations implemented by the VNA 133 of NMS 130 are described in U.S. Pat. No. 9,832,082, issued Nov. 28, 2017, and entitled “Monitoring Wireless Access Point Events,” U.S. Publication No. US 2021/0306201, published Sep. 30, 2021, and entitled “Network System Fault Resolution Using a Machine Learning Model,” U.S. Pat. No. 10,985,969, issued Apr. 20, 2021, and entitled “Systems and Methods for a Virtual Network Assistant,” U.S. Pat. No. 10,958,585, issued Mar. 23, 2021, and entitled “Methods and Apparatus for Facilitating Fault Detection and/or Predictive Fault Detection,” U.S. Pat. No. 10,958,537, issued Mar. 23, 2021, and entitled “Method for Spatio-Temporal Modeling,” and U.S. Pat. No. 10,862,742, issued Dec. 8, 2020, and entitled “Method for Conveying AP Error Codes Over BLE Advertisements,” all of which are incorporated herein by reference in their entirety.

In addition, as illustrated in FIG. 1B, NMS 130 may include a NAC controller 138 that implements a NAC configuration platform that provides a user interface to create and assign access policies for client devices 148 of enterprise networks 106, and provides the appropriate enterprise-specific configuration information 139 to the respective NAC systems 180A-180K. NMS 130 may have a secure connection 184A-184K, e.g., a RadSec tunnel or another encrypted tunnel, with each of NAC systems 180A-180K, respectively. Through secure connections 184, NAC controller 136 may receive network data 137, e.g., NAC event data, from each of NAC systems 180 and each of NAC systems 180 may download the appropriate configuration information 139 from NMS 130. In some examples, NAC controller 138 may log or map which enterprise networks are served by which of NAC systems 180. In addition, NAC controller 138 may monitor NAC systems 180 to identify failures of primary NAC systems and manage failovers to standby NAC systems.

NAC systems 180 provide network access control services in a control plane for one or more of NAS devices 108 at sites 102. In operation, NAC systems 180 authenticate client devices 148 to access enterprise wireless networks 106 and may perform fingerprinting to identify the client devices 148 and apply authorizations or access polices to the client devices 148 based on the identities. NAC systems 180 include multiple, geographically distributed points of presence. For example, NAC system 180A may comprise a first cloud-based system positioned within a first geographic region, e.g., U.S. East, NAC system 180B (not shown) may comprise a second cloud-based system positioned within a second geographic region, e.g., U.S. West, and NAC system 180K may comprise a kth cloud-based system positioned within a kth geographic region, e.g., China.

Deploying multiple NAC clouds at several geographic regions enables network access control services to be offered to nearby NAS devices with lower latency and high availability, while avoiding the processing limitations and maintenance issues experienced by on-premises NAC appliances. For example, NAS devices 108A within enterprise network site 102A may connect to the physically closest one of NAC systems, e.g., NAC system 180A, to experience lower latency for network access control services. In some examples, the physically closest one of NAC systems 180 may comprise a primary NAC system, and the NAS devices may also connect to a next closest one of NAC systems 180 as a standby NAC system in case of a failure of the primary NAC system. For example, NAS devices 108A within enterprise network site 102A may connect to both NAC system 180A and NAC system 108B (not shown), to experience high availability of network access control services.

In the example illustrated in FIG. 1B, each of the NAS devices 108, directly or indirectly, has a secure connection with at least one of NAC systems 180. For example, each of APs 142A within site 120A has a direct, secure connection 182A to NAC system 180A, e.g., a RadSec tunnel or another encrypted tunnel. Each of switch 146A and router 147A within site 120A has an indirect connection to NAC system 180A via edge device 150A. In this example, switch 146A and router 147A may not support establishment of a secure connection directly with NAC system 180A, but edge device 150A may provide a proxy through which switch 146A and router 147A may connect to NAC system 180A. For example, each of switch 146A and router 147A have a direct connection 178A, e.g., a RADIUS tunnel, to edge device 150A, and edge device 150A has a direct, secure connection 182A to NAC system 180A. Similarly, for site 102N, each of NAS devices 108N has an indirect connection to NAC system 180K via edge device 150N. In this example, APs 142N, switch 142N, and router 147N may not support establishment of a secure connection directly with NAC system 180K, but edge device 150N may provide a proxy through which NAS devices 108N may connect to NAC system 180K. For example, each of APs 142N, switch 146N, and router 147N have a direct connection 178N, e.g., a RADIUS tunnel, to edge device 150N, and edge device 150N has a direct, secure connection 182N to NAC system 180K.

Through secure connections 182, NAC systems 180 may receive network access requests from client devices 148 through NAS devices 108 (and in some cases edge devices 150) at nearby enterprise sites 102. In response to the network access requests, NAC systems 180 authenticate the requesting client devices using an AAA server. NAC system 180 may perform fingerprinting to identify the authenticated client devices, such as in accordance with one or more aspects of the techniques described in this disclosure. NAC systems 180 then enforce the appropriate access policies on the identities of the authenticated client devices per the enterprise-specific configuration information 139 downloaded from NMS 130. In accordance with one specific implementation, a computing device is part of each of NAC systems 180. In accordance with other implementations, each of NAC systems 180A-180K may comprise one or more computing devices, dedicated servers, virtual machines, containers, services, or other forms of environments for performing the techniques described herein.

In accordance with the techniques described in this disclosure, NAC systems 180 may provide network access anomaly detection and mitigation that improves network security for wired and/or wireless devices that use MAB and/or 802.1X authentication. For example, NAC systems 180 may include fingerprinting module 156 configured to obtain fingerprinting information of devices and authenticate devices based on the fingerprinting information.

For example, when a new device, e.g., client devices 148 or NAS devices 108), initially requests access to the network, the device sends a network access request to NAC system 180A to authenticate the device. For example, client device 148A-1 may send a network access request to an access point (if client device 148A-1 is wireless) or switch 146A (if client device 148A-1 is wired to switch 146A), which then forwards the network access request to NAC system 180A to authenticate client device 148A-1.

In response to receiving the network access request, NAC system 180A may determine whether the device is a new device requesting access to the network (e.g., the MAC address specified in the network access request does not match a MAC address stored in NAC system 180A) and may obtain, with fingerprinting module 156 and from one or more NAS devices 108A within site 102A, fingerprinting information of the client device and store the fingerprinting information of the client device mapped to a MAC address of the client device in fingerprint information 158.

In some examples, client device 148 may implement DHCP and send DHCP packets specifying one or more DHCP options (e.g., such as in one or more Type-Length-Value (TLV) fields of the DHCP packet) that define the network services of the client devices. As one example, client device 148A-1 may include DHCP options information in a DHCP packet sent to DHCP server 116 on a path that includes at least one of NAS devices 108A capable of snooping the DHCP packet. In this example, in response to receiving an initial network access request for client device 148A-1 to access the network, fingerprinting module 156 of NAC system 180A may obtain the DHCP options information (e.g., receive a copy of the DHCP packet) sent by client device 148A-1. For example, fingerprinting module 156 may obtain the DHCP options information from one of NAS devices 108A that is in the path of the DHCP request sent by client device 148A-1. The one of NAS services 108A is capable of snooping the DHCP request to glean the DHCP options information. Fingerprinting module 156 may store the DHCP options information mapped to a MAC address of client device 148A-1 in fingerprint information 158. Additional examples of DHCP options are described in S. Alexander, “DHCP Options and BOOTP Vendor Extensions,” Network Working Group, Request for Comments 2132, March 1997, the entire contents of which is incorporated by reference herein.

In some examples, client device 148 may implement LLDP and send Link Layer Discovery Protocol (LLDP) packets specifying capabilities, identity, and other information of the client devices. The information specified in an LLDP packet may include a system name and description, port name and description, VLAN name and identifier, IP network management address, capabilities of the device, MAC address and physical layer information, power information, and/or link aggregation information. As one example, client device 148A-1 may include LLDP information in an LLDP packet sent to NAS devices 108. In this example, in response to receiving an initial network access request for client device 148A-1 to access the network, fingerprinting module 156 may obtain the LLDP information (e.g., receive a copy of the LLDP packet) sent by client device 148A-1. For example, fingerprinting module 156 may obtain the LLDP information from a NAS device that received the LLDP packet sent by client device 148A-1. Fingerprinting module 156 may store the LLDP information mapped to a MAC address of client device 148A-1 in fingerprint information 158. Additional examples of LLDP are described in “IEEE Standards for Local and metropolitan area networks—Station and Media Access Control Connectivity Discovery,” IEEE 802.1 AB-2005, May 6, 2005, the entire contents of which is incorporated by reference herein.

In some examples, client device 148 may implement Cisco™ Discovery Protocol (CDP) and send CDP packets specifying capabilities, identity, and other information of the device. The information specified in a CDP packet may include hardware platform, hardware capabilities, Layer 3 address (IP address) of the client device, interface that generated the CDP packet, port ID, device type, name of the client device, and other information of the client device. As one example, client device 148A-1 may include CDP information in a CDP packet sent to NAS devices 108. In this example, in response to receiving an initial network access request for client device 148A-1 to access the network, fingerprinting module 156 may obtain the CDP information (e.g., receive a copy of the CDP packet) sent by AP device 142A-1. Fingerprinting module 156 may store the CDP information mapped to a MAC address of AP device 142A-1 in fingerprint information 158.

In some examples, client device 148 may implement HTTP and may send HTTP packets with an HTTP header used to identify the client devices and their capabilities, referred to as an “HTTP user agent.” As one example, client device 148A-1 may include HTTP user agent information in an HTTP packet sent to one or more NAS devices 108. In this example, in response to receiving an initial network access request for client device 148A-1 to access the network, fingerprinting module 156 may obtain the HTTP user agent information (e.g., receive a copy of the HTTP packet) sent by client device 148A-1 and extract the HTTP user agent information from the HTTP packet. In some examples, fingerprinting module 156 may obtain the HTTP user agent information from the one or more NAS devices 108. Fingerprinting module 156 may store the HTTP user agent information mapped to a MAC address of client device 148A-1 in fingerprint information 158. Additional examples of HTTP user agent are described in R. Fielding Ed., “Hypertext Transfer Protocol (HTTP/1.1): Semantics and Content,” Internet Engineering Task Force (IETF), Request for Comments 7231, June 2014, the entire contents of which is incorporated by reference herein.

In some examples, fingerprinting module 156 of NAC systems 180 may obtain location information associated with the device. In some examples, the location information may be different for a client device physically connected to a switch (referred to herein as “wired client device”) and a client device wirelessly connected to an AP device (referred to herein as “wireless client device”). For example, assume that client device 148A-1 has a physical connection (e.g., Ethernet cable) to switch 146A, and is thus a “wired client device.” In this example, fingerprinting module 156 may, in response to receiving an initial network access request for client device 148A-1 to access the network, obtain, e.g., from switch 146A, location information that specifies the port client device 148A-1 is connected to switch 146A. In this example, fingerprinting module 156 may store the location information (e.g., port) mapped to a MAC address of client device 148A-1 in fingerprint information 158.

As another example, assume that client device 148A-N has a wireless connection to one or more of APs 142A-1 through 142A-M, and is thus a “wireless client device.” In this example, fingerprinting module 156 may, in response to receiving an initial network access request for client device 148A-1 to access the network, obtain, e.g., from one or more of APs 142A-1 through 142A-M, location information that specifies a geolocation (e.g., coordinates) of client device 148A-N. The coordinates of client device 148A-N may be determined based on a triangulation of received signal strength indicator (RSSI) values detected from one or more of APs 142A-1 through 142A-M that detect a wireless signal from client device 148A-N. In some examples, fingerprinting module 156 may obtain the geolocation of client device 148A-N that were determined from NMS 130. Fingerprinting module 156 may store the location information (e.g., geolocation) mapped to a MAC address of client device 148A-N in fingerprint information 158.

In some examples, fingerprinting module 156 of NAC systems 180 may proactively obtain fingerprinting information. For example, fingerprinting module 156 may perform a network mapper (NMAP) scan to identify used and/or unused ports of network devices to identify client devices connected to the network.

As further described below, fingerprinting module 156 of NAC systems 180 may use fingerprint information 158 to authenticate client devices requesting access to the network. For example, client device 149 of an unauthorized user 151 may spoof a MAC address of client device 148A-1 or one of NAS devices 108A and sends a network access request to gain access to the network. NAC system 108A may receive a network access request for client device 149 that has the same MAC address as client device 148A-1. In this example, fingerprinting module 156 may determine that client device 149 is not a new device (e.g., has a recognized MAC address), and in response, determines whether the fingerprinting information of client device 149 has an anomaly to previously obtained fingerprinting information of client device 148A-1 (e.g., the information stored in fingerprint information 158).

Fingerprinting module 156 may obtain the fingerprinting information of client device 149 in a similar manner as described above. Fingerprinting module 156 may perform a lookup of the fingerprinting information of client device 149 against fingerprint information 158 and determine whether there are anomalies between the fingerprinting information of client device 149 and the fingerprinting information of client device 148A-1 stored in fingerprint information 158. In some examples, fingerprinting module 156 may determine whether DHCP options information of client device 149 match DHCP options information of client device 148A-1. Alternatively, or additionally, fingerprinting module 156 may determine whether LLDP information of client device 149 matches LLDP information of client device 148A-1. Alternatively, or additionally, fingerprinting module 156 may determine whether CDP information of client device 149 matches CDP information of client device 148A-1. Alternatively, or additionally, fingerprinting module 156 may determine whether HTTP user agent information of client device 149 matches HTTP user agent information of client device 148A-1. Alternatively, or additionally, fingerprinting module 156 may determine if there are any anomalies between location information of client device 149 and location information of client device 148A-1. For example, if client device 148A-1 is a wired client device, fingerprinting module 156 may determine if the port identifier of client device 149 is different than the port identifier of client device 148A-1. As another example, if client device 148A-1 is a wireless client device, fingerprinting module 156 may determine if the geolocation of client device 149 is different than the geolocation of client device 148A-1 or different than the expected geolocation of client device 148A-1 based on a mobility pattern of client device 148A-1. For example, NMS 130 may include an Artificial Intelligence (AI) engine to analyze location information to identify a mobility pattern of a wireless client device. Fingerprinting module 156 may use the mobility pattern to determine whether the geolocation of a client device is to be expected.

In some examples, fingerprinting module 156 may determine if there is an anomaly to a subset of the fingerprinting information. For example, NAC system 180A may be configured to not consider location information in the determination of whether there is an anomaly between the fingerprinting information of the client device associated with the subsequent network access request and the previously obtained fingerprinting information of the authorized client device.

Based on the determination that there is an anomaly between the fingerprinting information of client device 149 and fingerprinting information of client device 148A-1, fingerprinting module 156 may execute an access policy that specifies whether to permit or deny network access for client device 149. In some examples, an administrator may configure one or more access policies and associated policy assignment criteria. For example, an administrator may configure an access policy to deny client device 149 access to the network in response to determining any of the DHCP options information, LLDP information, CDP information, and/or HTTP user agent information deviates from the fingerprinting information of client device 148A-1 stored in fingerprint information 158. Alternatively, the administrator may configure an access policy to quarantine the client device's access to a quarantine VLAN or another less privileged VLAN to restrict access of the client device in response to determining any of the DHCP options information, LLDP information, CDP information, and/or HTTP user agent information deviates from the fingerprinting information of client device 148A-1 stored in fingerprint information 158.

In some examples, fingerprinting module 156 may not execute an access policy in response to a determination that there is one or more anomalies in the fingerprinting information. For example, assume that client device 148A-1 is a wireless client device (e.g., wireless projector) that may regularly move to different rooms. In this example, the client device 148A-1 may send a network access request to NAC system 180A each time client device 148A-1 is moved. Fingerprinting module 156 may determine that there is a change in the geolocation of client device 148A-1. Fingerprinting module 156 may send the current geolocation of client device 148A-1 to NMS 130, which in turn may identify, with the AI engine, whether the current geolocation of client device 148A-1 is within a mobility pattern of client device 148A-1. If the current geolocation of client device 148A-1 is within the mobility pattern of client device 148A-1, NMS 130 may send an indication to fingerprinting module 156 that the current location of client device 148A-1 is within the mobility pattern. In response to determining that the geolocation of client device 148A-1 is within the mobility pattern of client device 148A-1, fingerprinting module 156 may not execute an access policy and permit access for client device 148A-1. Alternatively, or additionally, if the current geolocation of client device 148A-1 is not within the mobility pattern of client device 148A-1, NMS 130 may send an indication to fingerprinting module 156 that the current location of client device 148A-1 is not within the mobility pattern. In response to determining that the geolocation of client device 148A-1 is not within the mobility pattern of client device 148A-1, fingerprinting module 156 may execute an access policy.

In some examples, fingerprinting module 156 may generate and send a notification to the administrator based on the implemented access policy. For instance, fingerprinting module 156 may generate and send a notification if fingerprinting module 156 implements an access policy to deny or quarantine a client device's access to the network. In some examples, the notification may include an indication of a severity level of the unauthorized client device's attempt to access the network.

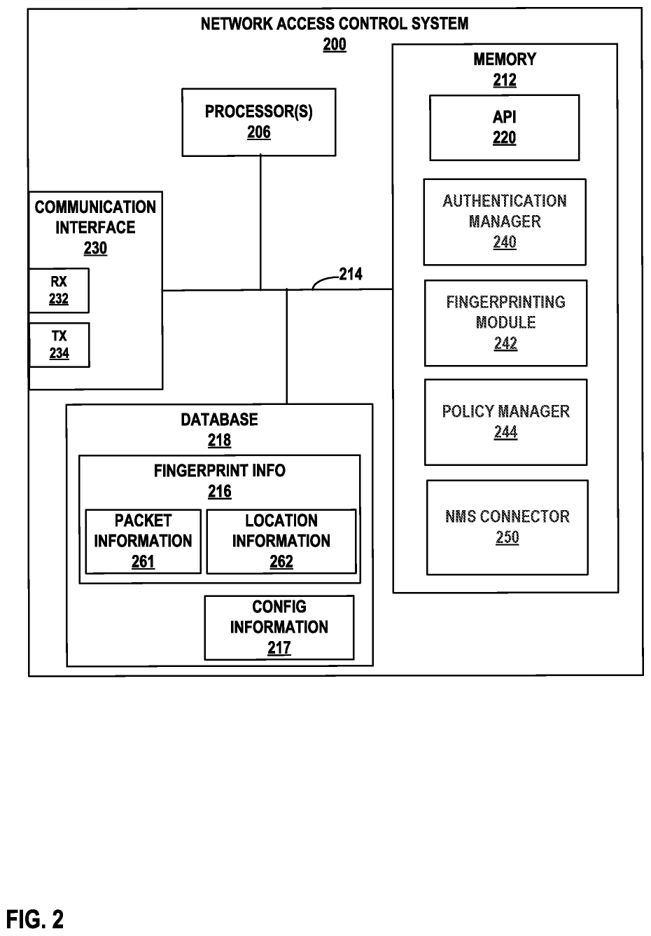

FIG. 2 is a block diagram of an example network access control (NAC) system 200, in accordance with one or more techniques of the disclosure. NAC system 200 may be used to implement, for example, any of NAC systems 180 in FIGS. 1A, 1B. In such examples, NAC system 200 is responsible for authenticating and authorizing one or more client devices 148 to access enterprise wireless networks 106 at a sub-set of nearby enterprise sites 102A-102N.

NAC system 200 includes a communications interface 230, one or more processor(s) 206, a user interface 210, a memory 212, and a database 218. The various elements are coupled together via a bus 214 over which the various elements may exchange data and information. In some examples, NAC system 200 receives network access requests from one or more of client devices 148 through NAS devices 108 (and in some cases edge devices 150) at the sub-set of nearby enterprise sites 102 from FIGS. 1A, 1B. In response to the network access requests, NAC system 200 authenticates the requesting client devices. In some examples, NAC system 200 enforces appropriate access policies on the authenticated client devices in accordance with enterprise-specific configuration information 217 downloaded from NMS 130 from FIGS. 1A, 1B. In some examples, NAC system 200 may be part of another server shown in FIGS. 1A, 1B or a part of any other server.

Processor(s) 206 execute software instructions, such as those used to define a software or computer program, stored to a computer-readable storage medium (such as memory 212), such as non-transitory computer-readable mediums including a storage device (e.g., a disk drive, or an optical drive) or a memory (such as Flash memory or RAM) or any other type of volatile or non-volatile memory, that stores instructions to cause the one or more processors 306 to perform the techniques described herein.

Communications interface 230 may include, for example, an Ethernet interface. Communications interface 230 couples NAC system 200 to a network and/or the Internet, such as any of network 134 as shown in FIG. 1A and/or any local area networks. Communications interface 230 includes a receiver 232 and a transmitter 234 by which NAC system 200 receives/transmits data and information to/from any of APs 142, switches 146, routers 147, edge devices 150, NMS 130, or servers 116, 122, 128 and/or any other network nodes, devices, or systems forming part of network system 100 such as shown in FIGS. 1A, 1B.

The data and information received by NAC system 200 may include, for example, configuration information 217 associated with one or more of enterprise sites 102 that is downloaded from NMS 130. Configuration information 217 may include enterprise-specific NAC configuration information, including access policies and associated policy assignment criteria. For example, configuration information 217 may define certain virtual local area networks (VLANs), access control lists (ACLs), registration portals, or the like, associated with certain categories of client devices. Configuration information 217 may further define, for each of the different categories of the client devices, different types of tracking, different types of authorization, and/or different levels of access privileges. In addition, the data and information received by NAC system 200 may include identification information of client devices 148 from NAS devices 108 that is used by NAC system 200 to perform fingerprinting of the end user devices in order to enforce the access policies as defined in fingerprint information 216. As described above, fingerprint information 216 may include DHCP options used to request IP addresses, information specified in LLDP packets, information specified in CDP packets, HTTP user agent information, location information, and/or device type and operating system information. NAC system 200 may further transmit data and information via communications interface 330 to NMS 130 including, for example, NAC event data, which may be used by NMS 130 to remotely monitor the performance of NAC system 200.

Memory 212 includes one or more devices configured to store programming modules and/or data associated with operation of NAC system 200. For example, memory 212 may include a computer-readable storage medium, such as a non-transitory computer-readable medium including a storage device (e.g., a disk drive, or an optical drive) or a memory (such as Flash memory or RAM) or any other type of volatile or non-volatile memory, that stores instructions to cause the one or more processor(s) 206 to perform the techniques described herein.

In this example, memory 212 includes an API 220, an authentication manager 240, a fingerprinting module 240, a policy manager 244, and an NMS connector 250. NAC system 200 may also include any other programmed modules, software engines and/or interfaces configured for authentication and authorization of client devices 148.

Authentication manager 240 enables authentication of client devices 148 at NAS devices 108 to access wireless networks 106, such as branch or campus enterprise networks, at the sub-set of enterprise sites 102 in communication with NAC system 200. Authentication manager 240 may perform the functionality of an AAA server, e.g., a RADIUS server, or provide access to an AAA server to authenticate client devices 148 prior to providing access to the enterprise networks 106 via the NAS devices 108. In some examples, authentication manager 240 may participate in a handshake exchange between a client device, an NAS device, and NAC system 200 controlling access at the NAS device. In other examples, authentication manager 240 may enable certificate-based authentication of client devices or enable interaction with cloud directory services to authenticate the client devices.

Fingerprinting module 242 enables identification of client devices 148 used to provide the client devices with appropriate authorizations or access policies based on their identities or categorizations. Fingerprinting module 242 may operate substantially similar to fingerprinting module 156 of FIGS. 1A and 1B. Fingerprinting module 242 may identify client devices 148 by analyzing network behavior of the client devices. Fingerprinting module 242 may receive the network behavior data of the client devices from the NAS devices 108 and/or edge devices 150 in communication with NAS system 200. For example, fingerprinting module 242 may perform fingerprinting of client devices 148 based on one or more of MAC addresses, DHCP options information used to request IP addresses, LLDP information, CDP information, HTTP user agent information, location information, and/or device type and operating system information.

Policy manager 244 enables enforcement of the authorizations or access policies based on the identities or categorizations of the authenticated client devices. For example, policy manager 244 may assign the authenticated client devices to certain VLANs, apply certain ACLs, direct the client devices to certain registration portals, or the like, that are each associated with different types of tracking, different types of authorization, and/or different levels of access privileges in accordance with configuration information 217 for the corresponding enterprise of the client devices. In some examples, after a client device gains access to the enterprise network, policy manger 244 may monitor activities of the client device to identify security concerns and, in response, re-assign the client device to a quarantine VLAN or another less privileged VLAN to restrict access of the client device.

NMS connector 250 manages the data and information exchanged between NAC system 200 and NMS 130, e.g., via a RadSec tunnel or another encrypted tunnel 184, as shown in FIG. 1B. NMS connector 250 may maintain a log or mapping of which enterprise networks are served by NAC system 200 and the corresponding configuration information 217 for those enterprises. NMS connector 250 may also manage any updates or modifications to configuration information 217 received from NMS 130.

In accordance with the techniques described in this disclosure, NAC system 200 may enforce authorizations or access policies based fingerprinting information. For example, NAC system 200 may receive configuration information 217 (e.g., from NMS 130) including one or more access policies based on fingerprinting information. Fingerprinting module 242 may obtain, from one or more NAS devices 108A within site 102A, fingerprinting information of a client device (e.g., client device 148A-1 of FIG. 1A) and, if client device is a new client device and authorized, store the fingerprinting information of the client device mapped to a MAC address of the client device in fingerprint information 216.

For example, fingerprint information 216 may include packet information 261 and location information 262. Packet information 261 may include DHCP options information used to request IP addresses, LLDP information, CDP information, HTTP user agent information, and/or any other information from packets sent by the client device. Location information 262 may include port information (e.g., if the client device is a wired client device) and/or geolocation information (e.g., if the client device is a wireless client device).

Fingerprinting module 242 may use the information in fingerprint information 216 to authenticate client devices requesting for access to the network. For example, in response to NAC system 200 receiving a subsequent network access request for a client device (e.g., client device 149), fingerprinting module 242 may obtain fingerprinting information of the associated with the subsequent network access request. Fingerprinting module 242 may determine whether the client device associated with the subsequent network access request is a new client device that is requesting access to the network, e.g., by determining whether the MAC address of the client device requesting for access is known. In response to determining that the client device is not a new client device (e.g., MAC address is recognized due to spoofing MAC address of client device 148A-1), fingerprinting module 242 may perform a lookup of the fingerprinting information of the client device associated with the subsequent network access request against the previously obtained fingerprinting information of the client device associated with the prior network access request in fingerprint information 216. In some examples, fingerprinting module 242 may determine, for a wired client device, if there is any anomaly between the packet information or location information of the client device associated with the subsequent network access request and the previously obtained packet information 261 or location information 262 in fingerprint information 216. In response to determining there is an anomaly to packet information 261 or location information 262, fingerprinting module 242 may instruct policy manager 244 to enforce the authorizations or access policies based on the determination of any anomaly to packet information 261 or location information 262.

In some examples, fingerprinting module 242 may determine, for a wireless client device and in response to determining that there is no anomaly between the packet information of the client device associated with the subsequent network access request and packet information 261, whether the location information (e.g., geolocation) of the client device associated with the subsequent network access request deviates from location information 262 in fingerprint information 216. In these examples, fingerprinting module 242 may obtain, from NMS 130, information indicating whether the geolocation information is not within a mobility pattern of the client device. In response to determining that the geolocation information of the client device associated with the subsequent network access request is not within the mobility pattern of the client device associated with the prior network access request, fingerprinting module 242 may instruct policy manager 244 to enforce the authorizations or access policies to manage the network access of the client device associated with the subsequent network access request.

In some examples, fingerprinting module 216 may generate and send a notification to the administrator based on the implemented access policy. For instance, fingerprinting module 216 may generate and send a notification if fingerprinting module 216 implements an access policy to deny or quarantine a client device's access to the network. In some examples, the notification may include an indication of a severity level of the unauthorized client device's attempt to access the network.

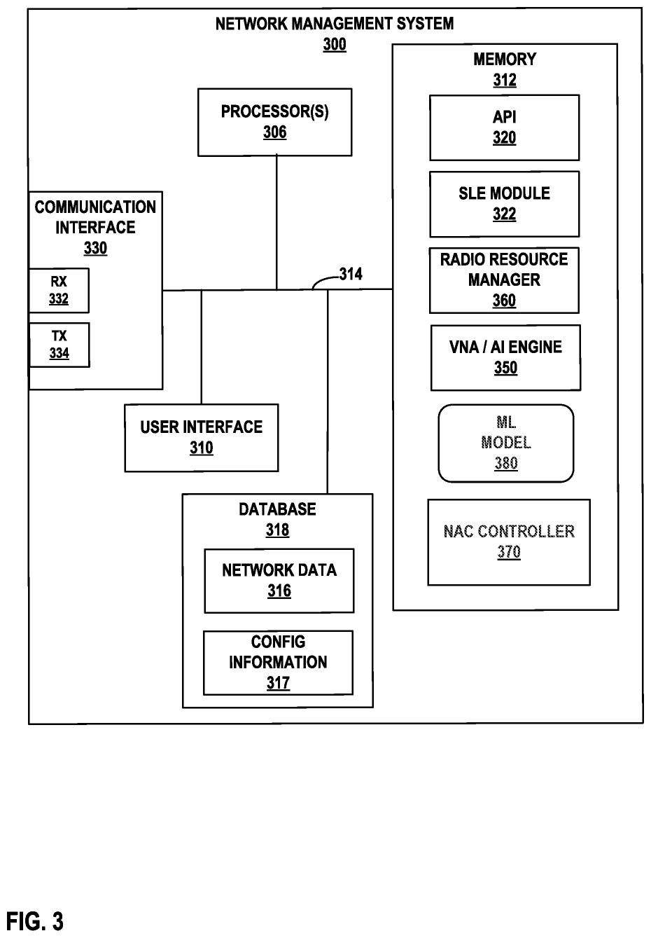

FIG. 3 is a block diagram of an example network management system (NMS) 300, in accordance with one or more techniques of the disclosure. NMS 300 may be used to implement, for example, NMS 130 in FIGS. 1A, 1B. In such examples, NMS 300 is responsible for monitoring and management of one or more wireless networks 106A-106N at sites 102A-102N, respectively.

NMS 300 includes a communications interface 330, one or more processor(s) 306, a user interface 310, a memory 312, and a database 318. The various elements are coupled together via a bus 314 over which the various elements may exchange data and information. In some examples, NMS 300 receives data from one or more of client devices 148, APs 142, switches 146, routers, 147, edge devices 150, NAC systems 180, and other network nodes within network 134, e.g., routers and gateway devices, which may be used to calculate one or more SLE metrics and/or update network data 316 in database 318. NMS 300 analyzes this data for cloud-based management of wireless networks 106A-106N. In some examples, NMS 300 may be part of another server shown in FIG. 1A or a part of any other server.

Processor(s) 306 execute software instructions, such as those used to define a software or computer program, stored to a computer-readable storage medium (such as memory 312), such as non-transitory computer-readable mediums including a storage device (e.g., a disk drive, or an optical drive) or a memory (such as Flash memory or RAM) or any other type of volatile or non-volatile memory, that stores instructions to cause the one or more processors 306 to perform the techniques described herein.

Communications interface 330 may include, for example, an Ethernet interface. Communications interface 330 couples NMS 300 to a network and/or the Internet, such as any of network(s) 134 as shown in FIG. 1A, and/or any local area networks. Communications interface 330 includes a receiver 332 and a transmitter 334 by which NMS 300 receives/transmits data and information to/from any of client devices 148, APs 142, switches 146, routers 147, edge devices 150, NAC systems 180, servers 116, 122, 128 and/or any other network nodes, devices, or systems forming part of network system 100 such as shown in FIG. 1A. In some scenarios described herein in which network system 100 includes “third-party” network devices that are owned and/or associated with different entities than NMS 300, NMS 300 does not directly receive, collect, or otherwise have access to network data from the third-party network devices. In some examples, an edge device, such as edge devices 150 from FIGS. 1A, 1B, may provide a proxy through which the network data of the third-party network devices may be reported to NMS 300.

The data and information received by NMS 300 may include, for example, telemetry data, SLE-related data, or event data received from one or more of client device APs 148, APs 142, switches 146, routers 147, edge devices 150, NAC systems 180, or other network nodes, e.g., routers and gateway devices, used by NMS 300 to remotely monitor the performance of wireless networks 106A-106N and application sessions from client device to cloud-based application server. NMS 300 may further transmit data via communications interface 330 to any of the network devices, such as client devices 148, APs 142, switches 146, routers 147, edge devices 150, NAC systems 180, or other network nodes within network 134, to remotely manage wireless networks 106A-106N and portions of the wired network.

Memory 312 includes one or more devices configured to store programming modules and/or data associated with operation of NMS 300. For example, memory 312 may include a computer-readable storage medium, such as a non-transitory computer-readable medium including a storage device (e.g., a disk drive, or an optical drive) or a memory (such as Flash memory or RAM) or any other type of volatile or non-volatile memory, that stores instructions to cause the one or more processor(s) 306 to perform the techniques described herein.

In this example, memory 312 includes an API 320, an SLE module 322, a virtual network assistant (VNA)/AI engine 350, a radio resource management (RRM) engine 360, and a NAC controller 370. NMS 300 may also include any other programmed modules, software engines and/or interfaces configured for remote monitoring and management of wireless networks 106A-106N and portions of the wired network, including remote monitoring and management of any of APs 142, switches 146, routers 147, edge devices 150, NAC systems 180, or other network devices, e.g., routers and gateway devices.

SLE module 322 enables set up and tracking of thresholds for SLE metrics for each network 106A-106N. SLE module 322 further analyzes SLE-related data collected by, e.g., APs, such as any of APs 142 from UEs in each wireless network 106A-106N. For example, APs 142A-1 through 142A-N collect SLE-related data from UEs 148A-1 through 148A-N currently connected to wireless network 106A. This data is transmitted to NMS 300, which executes by SLE module 322 to determine one or more SLE metrics for each UE 148A-1 through 148A-N currently connected to wireless network 106A. This data, in addition to any network data collected by one or more APs 142A-1 through 142A-N in wireless network 106A, is transmitted to NMS 300 and stored as, for example, network data 316 in database 318.

RRM engine 360 monitors one or more metrics for each site 102A-102N in order to learn and optimize the RF environment at each site. For example, RRM engine 360 may monitor the coverage and capacity SLE metrics for a wireless network 106 at a site 102 in order to identify potential issues with SLE coverage and/or capacity in the wireless network 106 and to make adjustments to the radio settings of the access points at each site to address the identified issues. For example, RRM engine may determine channel and transmit power distribution across all APs 142 in each network 106A-106N. For example, RRM engine 360 may monitor events, power, channel, bandwidth, and number of clients connected to each AP. RRM engine 360 may further automatically change or update configurations of one or more APs 142 at a site 102 with an aim to improve the coverage and capacity SLE metrics and thus to provide an improved wireless experience for the user. In some examples, RRM engine may determine geolocation of a wireless client device, e.g., by triangulating the location of the client device based on RSSI values obtained from one or more APs 142.

VNA/AI engine 350 analyzes data received from network devices as well as its own data to identify when undesired to abnormal states are encountered at one of the network devices. For example, VNA/AI engine 350 may identify the root cause of any undesired or abnormal states, e.g., any poor SLE metric(s) indicative of connected issues at one or more network devices. In addition, VNA/AI engine 350 may automatically invoke one or more corrective actions intended to address the identified root cause(s) of one or more poor SLE metrics. In some examples, ML model 380 may comprise a supervised ML model that is trained, using training data comprising pre-collected, labeled network data received from the network devices. The supervised ML model may comprise one of a logistical regression, naïve Bayesian, support vector machine (SVM), or the like. In other examples, ML model 380 may comprise an unsupervised ML model. Although not shown in FIG. 3, in some examples, database 318 may store the training data and VNA/AI engine 350 or a dedicated training module may be configured to train ML model 380 based on the training data to determine appropriate weights across the one or more features of the training data. For example, database 318 may store geolocation data of client devices to train ML model 380 based on the training data to determine a mobility pattern of the client devices. VNA/AI engine 350 may provide an indication of whether or not geolocation information of a client device is within the mobility pattern.

Examples of corrective actions that may be automatically invoked by VNA/AI engine 350 may include, but are not limited to, invoking RRM 360 to reboot one or more APs, adjusting/modifying the transmit power of a specific radio in a specific AP, adding SSID configuration to a specific AP, changing channels on an AP or a set of APs, etc. The corrective actions may further include restarting a switch and/or a router, invoking downloading of new software to an AP, switch, or router, etc. These corrective actions are given for example purposes only, and the disclosure is not limited in this respect. If automatic corrective actions are not available or do not adequately resolve the root cause, VNA/AI engine 350 may proactively provide a notification including recommended corrective actions to be taken by IT personnel, e.g., a site or network administrator using admin device 111, to address the network error.

NAC controller 370 implements a NAC configuration platform that provides user interface 310 for display to an enterprise network administrator, e.g., via admin device 111 of FIG. 1A, through which to receive access policy information for the enterprise network. NAC controller 370 creates enterprise-specific configuration information 317 stored in database 318 based on the input received via user interface 310. Configuration information 317 may include NAC configuration information for one or more enterprise networks managed by NMS 300. For each enterprise, configuration information 317 may including access policies and associated policy assignment criteria. For example, configuration information 317 may define certain VLANs, ACLs, registration portals, or the like, associated with certain categories of client devices, and may further define, for each of the different categories of the client devices, different types of tracking, different types of authorization, and/or different levels of access privileges. Configuration information 317 may be substantially similar to configuration information 139 of FIG. 1B.

NAC controller 370 manages the data and information exchanged between NMS 300 and NAC systems 180, e.g., via RadSec tunnels or another encrypted tunnels 184, as shown in FIG. 1B. NAC controller 370 may maintain a log or mapping of which enterprise networks are served by which of NAC systems 180 and the corresponding configuration information 317 for those enterprises. NAC controller 370 may also manage any updates or modifications to configuration information 317 to be pushed down to NAC systems 180. In addition, NAC controller 370 may monitor NAC systems 180 to identify failures of primary NAC systems and manage failovers to standby NAC systems.

In accordance with one or more techniques of this disclosure, NAC controller 370 may create configuration information 317 that defines one or more access policies based on fingerprint information. For example, NAC controller 370 may receive input via user interface 310 specifying access policy information to deny a client device's access to the network if there is an anomaly between fingerprinting information of a client device associated with a subsequent network access request and fingerprinting information of a client device associated with a prior network access request. The configuration information may define a quarantine VLAN or another less privileged VLAN to restrict access of a client device if there is an anomaly between fingerprinting information of a client device associated with a subsequent network access request and fingerprinting information of a client device associated with a prior network access request. In some examples, NAC controller 370 may receive input via user interface 310 specifying access policy information to permit a client device's access to the network if there is an anomaly between geolocation information of a wireless client device associated with a subsequent network access and geolocation information of a wireless client device associated with a prior network access request, and the geolocation information is determined to be within a mobility pattern of the wireless client device associated with the prior network access request. In some examples, NAC controller 370 may receive input via user interface 310 specifying access policy information to deny a client device's access to the network if there is an anomaly between geolocation information of a wireless client device associated with a subsequent network access request and geolocation information of a wireless client device associated with a prior network access request, and the geolocation information is determined to be not within the mobility pattern of the wireless client device associated with the prior network access request. NAC controller 370 may push the configuration information 317 including the one or more access policies down to NAC systems 180, which in turn may use the configuration information to configure the NAC system to implement the one or more access policies based on fingerprinting information.

In some examples, NAC controller 370 may receive input via user interface 310 specifying configuration information 317 to configure NAC systems 180 to generate and send a notification to the administrator based on the implemented access policy. For instance, configuration information 317 may include configuration information to configure fingerprinting module 156 to generate and send a notification if fingerprinting module 156 implements an access policy to deny or quarantine a client device's access to the network. In some examples, the notification may include an indication of a severity level of the unauthorized client device's attempted access to the network.

Although the techniques of the present disclosure are described in this example as performed by NMS 130, techniques described herein may be performed by any other computing device(s), system(s), and/or server(s), and that the disclosure is not limited in this respect. For example, one or more computing device(s) configured to execute the functionality of the techniques of this disclosure may reside in a dedicated server or be included in any other server in addition to or other than NMS 130, or may be distributed throughout network 100, and may or may not form a part of NMS 130.

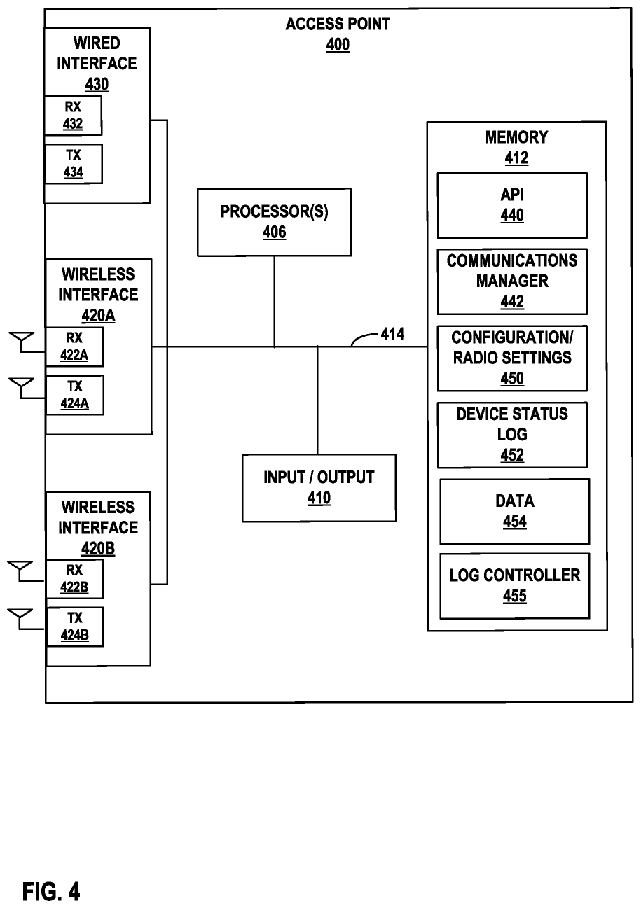

FIG. 4 is a block diagram of an example access point (AP) device 400, in accordance with one or more techniques of this disclosure. Example access point 400 shown in FIG. 4 may be used to implement any of APs 142 as shown and described herein with respect to FIG. 1A. Access point 400 may comprise, for example, a Wi-Fi, Bluetooth and/or Bluetooth Low Energy (BLE) base station or any other type of wireless access point.

In the example of FIG. 4, access point 400 includes a wired interface 430, wireless interfaces 420A-420B one or more processor(s) 406, memory 412, and input/output 410, coupled together via a bus 414 over which the various elements may exchange data and information. Wired interface 430 represents a physical network interface and includes a receiver 432 and a transmitter 434 for sending and receiving network communications, e.g., packets. Wired interface 430 couples, either directly or indirectly, access point 400 to a wired network device, such as one of switches 146 or routers 147 of FIGS. 1A, 1B, within the wired network via a cable, such as an Ethernet cable.

First and second wireless interfaces 420A and 420B represent wireless network interfaces and include receivers 422A and 422B, respectively, each including a receive antenna via which access point 400 may receive wireless signals from wireless communications devices, such as UEs 148 of FIGS. 1A, 1B. First and second wireless interfaces 420A and 420B further include transmitters 424A and 424B, respectively, each including transmit antennas via which access point 400 may transmit wireless signals to wireless communications devices, such as UEs 148 of FIGS. 1A, 1B. In some examples, first wireless interface 420A may include a Wi-Fi 802.11 interface (e.g., 2.4 GHz and/or 5 GHz) and second wireless interface 420B may include a Bluetooth interface and/or a Bluetooth Low Energy (BLE) interface. As described above, AP 400 may request network access for one or more UEs 148 from a nearby NAC system, e.g., NAC system 200 of FIG. 2 or one of NAC systems 180 of FIGS. 1A, 1B.

Processor(s) 406 are programmable hardware-based processors configured to execute software instructions, such as those used to define a software or computer program, stored to a computer-readable storage medium (such as memory 412), such as non-transitory computer-readable mediums including a storage device (e.g., a disk drive, or an optical drive) or a memory (such as Flash memory or RAM) or any other type of volatile or non-volatile memory, that stores instructions to cause the one or more processors 406 to perform the techniques described herein.

Memory 412 includes one or more devices configured to store programming modules and/or data associated with operation of access point 400. For example, memory 412 may include a computer-readable storage medium, such as non-transitory computer-readable mediums including a storage device (e.g., a disk drive, or an optical drive) or a memory (such as Flash memory or RAM) or any other type of volatile or non-volatile memory, that stores instructions to cause the one or more processor(s) 406 to perform the techniques described herein.

In this example, memory 412 stores executable software including an application programming interface (API) 440, a communications manager 442, configuration settings 450, a device status log 452, data storage 454, and log controller 455. Device status log 452 includes a list of events specific to access point 400. The events may include a log of both normal events and error events such as, for example, memory status, reboot or restart events, crash events, cloud disconnect with self-recovery events, low link speed or link speed flapping events, Ethernet port status, Ethernet interface packet errors, upgrade failure events, firmware upgrade events, configuration changes, etc., as well as a time and date stamp for each event. Log controller 455 determines a logging level for the device based on instructions from NMS 130. Data 454 may store any data used and/or generated by access point 400, including data collected from UEs 148, such as data used to calculate one or more SLE metrics, that is transmitted by access point 400 for cloud-based management of wireless networks 106A by NMS 130/300.

Input/output (I/O) 410 represents physical hardware components that enable interaction with a user, such as buttons, a display, and the like. Although not shown, memory 412 typically stores executable software for controlling a user interface with respect to input received via I/O 410. Communications manager 442 includes program code that, when executed by processor(s) 406, allow access point 400 to communicate with UEs 148 and/or network(s) 134 via any of interface(s) 430 and/or 420A-420C. Configuration settings 450 include any device settings for access point 400 such as radio settings for each of wireless interface(s) 420A-420C. These settings may be configured manually or may be remotely monitored and managed by NMS 130 to optimize wireless network performance on a periodic (e.g., hourly or daily) basis.

As described herein, AP device 400 may measure and report network data from status log 452 to NMS 130. The network data may comprise event data, telemetry data, and/or other SLE-related data. The network data may include various parameters indicative of the performance and/or status of the wireless network. The parameters may be measured and/or determined by one or more of the UE devices and/or by one or more of the APs in a wireless network. NMS 130/300 may determine one or more SLE metrics based on the SLE-related data received from the APs in the wireless network and store the SLE metrics as network data 137 (FIG. 1B).

In accordance with the techniques described in this disclosure, AP device 400 may send fingerprinting information associated with client devices to NAC systems 180. For example, data 454 may include fingerprinting information collected from packets sent by UEs 148. For example, data 454 may include DHCP information from DHCP packets, LLDP information from LLDP packets, CDP information from CDP packets, HTTP user agent information from HTTP packets, and/or other identifying information sent by UEs 148. In some examples, data 454 may include a copy of the various packets sent by UEs 148. In some examples, data 454 may include RSSI values of UEs 148 that can be used to determine geolocation of UEs 148.

AP device 400 may provide the collected fingerprinting information to NAC systems 180. For example, NAC system 180 may send a request to AP device 400 for fingerprinting information of a client device connected to AP device 400. AP device 400 may provide the fingerprinting information, such as a copy of a DHCP packet, LLDP packet, CDP packet, HTTP packet, or any other packet including information identifying a client device or network behavior of the client device.

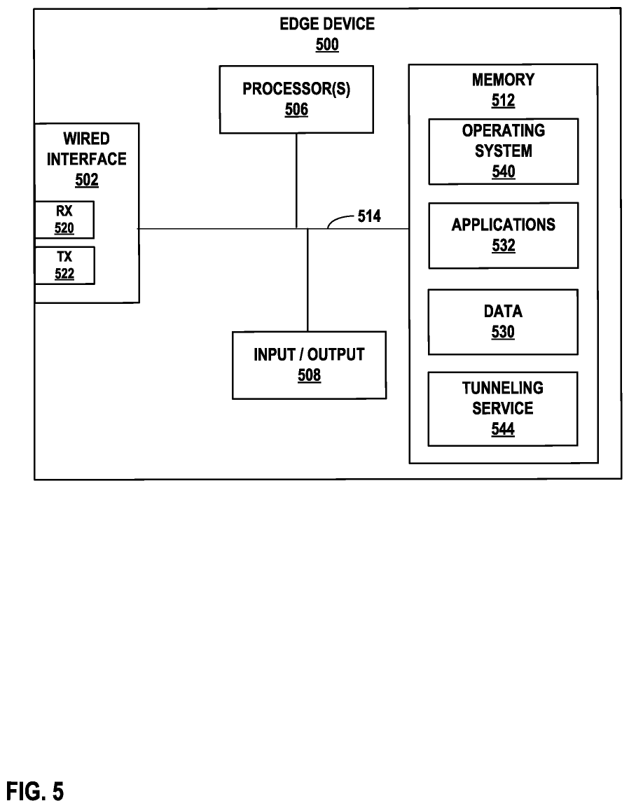

FIG. 5 is a block diagram illustrating an example edge device 500, in accordance with one or more techniques of this disclosure. Edge device 500 comprises a cloud-managed, wireless local area network (LAN) controller. Edge device 500 may be used to implement, for example, any of edge devices 150 in FIGS. 1A, 1B. In such examples, edge device 500 comprises an on-premises device at a site 102 that is in communication with NMS 130 and one or more on-premises NAS devices 108, e.g., one or more APs 142, switches 146, or routers 147, from FIGS. 1A, 1B. Edge device 500 with NMS 130 and may operate to extend certain microservices from NMS 130 to the on-premises NAS devices 108 while using NMS 130 and its distributed software architecture for scalable and resilient operations, management, troubleshooting, and analytics.

In this example, edge device 500 includes a wired interface 502, e.g., an Ethernet interface, a processor 506, input/output 508, e.g., display, buttons, keyboard, keypad, touch screen, mouse, etc., and a memory 512 coupled together via a bus 514 over which the various elements may interchange data and information. Wired interface 502 couples edge device 500 to a network, such as network 134 shown in FIG. 1A and/or any local area networks. Wired interface 502 includes a receiver 520 and a transmitter 522 by which edge device 500 receives/transmits data and information to/from any of NAS devices 108 and NMS 130 and/or NAC systems 180. Though only one interface is shown by way of example, edge device 500 may have multiple communication interfaces and/or multiple communication interface ports.

Memory 512 stores executable software applications 532, operating system 540 and data/information 530. Data 530 may include a system log and/or an error log that stores event data, including behavior data, for edge device 500. Tunneling service 544 provides on-premises tunnel termination from APs and other NAS devices. Tunneling service 544 further provides a secure tunnel proxy to NMS 130 and/or NAC systems 180. In one scenario, one or more of the NAS devices 108, e.g., switch 146A from FIG. 1B, may not support establishment of RadSec tunnels directly with NMS 130 and/or NAC systems 180. In this scenario, tunneling service 544 of edge device 500 provides a RadSec proxy to enable RADIUS packets received from switch 146A via a RADIUS tunnel 178A to be tunneled to NAC system 180A using a RadSec tunnel 182A, as shown in FIG. 1B.

In accordance with the techniques described in this disclosure, edge device 500 may send fingerprinting information associated with client devices to NAC systems 180. For example, data 530 may include fingerprinting information collected from packets sent by UEs 148. For example, data 530 may include DHCP information from DHCP packets, LLDP information from LLDP packets, CDP information from CDP packets, HTTP user agent information from HTTP packets, and/or other identifying information sent by UEs 148. In some examples, data 530 may include a copy of the various packets sent by UEs 148. In some examples, data 530 may include port information (e.g., port identifier) of UEs 148 that are connected to one or more switches (e.g., switch 146A) coupled to edge device 500.

Edge device 500 may provide the collected fingerprinting information to NAC systems 180. For example, NAC system 180 may send a request to edge device 500 for fingerprinting information of a client device connected to a switch coupled to edge device 500. Edge device 500 may provide the fingerprinting information, such as a copy of a DHCP packet, LLDP packet, CDP packet, HTTP packet, port information, or any other packet including information identifying a client device or network behavior of the client device.

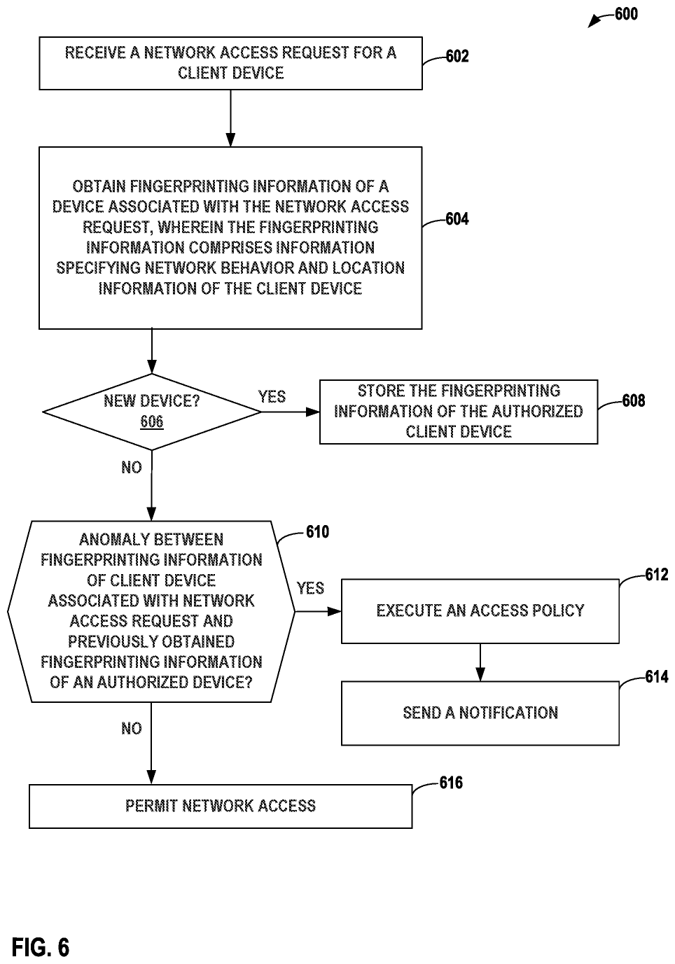

FIG. 6 is a flow chart illustrating an example operation 600 to obtain fingerprinting information of client devices and use the fingerprinting information to authenticate client devices requesting to access the network, in accordance with one or more techniques of this disclosure. For ease of illustration, operation 600 is described with respect to any of NAC systems 180 of FIGS. 1A and 1B, and NAC system 200 of FIG. 2.

In this example, NAC system 180A receives a network access request for a client device to access a network (602). NAC system 180A may receive a network access request for a client device to access the network via a NAS device 108A, such as access points (APs) 142, switches 146, and routers 147, or any network infrastructure devices capable of authenticating and authorizing client devices to access an enterprise network.

In response to receiving the network access request, NAC system 180A obtains fingerprinting information of the client device associated with the network access request (604). For example, fingerprinting module 156 of NAC system 180A may obtain, from one or more NAS devices 108A, information specifying network behavior and location information of the client device associated with the network access request. As described above, fingerprinting information may include DHCP options used to request IP addresses, link layer discovery protocol (LLDP) packets, Hypertext Transfer Protocol (HTTP) user agent information, location information (e.g., port information if wired client device, geolocation if wireless client device), and/or device type and operating system information.

NAC system 180A determines whether the client device associated with the network access request is a new client device requesting access to the network (606). For example, fingerprinting module 156 of NAC system 180A may determine whether a MAC address of the client device associated with the network access request is recognized (e.g., matches a MAC address stored in the NAC system). In response to determining that the client device associated with the network access request is a new client device that is requesting access to the network (“YES” of step 606), NAC system 180A may store the fingerprinting information of the authorized client device associated with the network access request in fingerprint information 158 (608).

NAC system 180A may use the information stored in fingerprint information 158 to authenticate client devices requesting to access the network. For example, NAC system 180A may receive a subsequent network access request for a client device associated with the subsequent network access request (602). In response to receiving the subsequent network access request, NAC system 180A obtains fingerprinting information of the client device associated with the subsequent network access request (604). NAC system 180A determines whether the client device associated with the subsequent network access request is a new client device requesting access to the network (606). As one example, the client device associated with the subsequent network access request may have a MAC address that matches a MAC address of authorized client device.

In response to determining that the client device associated with the network access request is not a new client device that is requesting access to the network (“NO” of step 606), NAC system 180A may determine whether the fingerprinting information of the client device associated with the subsequent network access request has an anomaly to previously obtained fingerprinting information of an authorized client device (610). For example, fingerprinting module 156 of NAC system 180A may determine whether DHCP options information of the client device associated with the subsequent network access request match DHCP options information of the authorized client device, LLDP information of the client device associated with the subsequent network access request matches LLDP information of the authorized client device, CDP information of the client device associated with the subsequent network access request matches CDP information of the authorized client device, HTTP user agent information of the client device associated with the subsequent network access request matches HTTP user agent information of the authorized client device.

Alternatively, or additionally, fingerprinting module 156 may determine if there are any anomalies between location information of the client device associated with the subsequent network access request and location information of the authorized client device. For example, if the client device is a wired client device, fingerprinting module 156 may determine whether information identifying the port of the client device associated with the subsequent network access request does not match information identifying the port of the authorized client device. As another example, if the authorized client device is a wireless client device, fingerprinting module 156 may determine whether the geolocation of the client device associated with the subsequent network access request does not match the geolocation of the authorized client device or is not within the expected geolocation of a mobility pattern of the authorized client device. For example, NMS 130 may include an Artificial Intelligence (AI) engine to analyze location information to identify a mobility pattern of a wireless client device. Fingerprinting module 156 may use the mobility pattern to determine whether the geolocation of a client device is to be expected. In some examples, fingerprinting module 156 may determine if there is an anomaly to a subset of the fingerprinting information. For example, NAC system 180A may be configured to not consider location information in the determination of whether there is an anomaly between the fingerprinting information of the client device associated with the subsequent network access request and the previously obtained fingerprinting information of the authorized client device.

In response to determining that the fingerprinting information of the client device associated with the subsequent network access request has an anomaly to previously obtained fingerprinting information of the authorized client device (“YES” of step 610), NAC system 180A may execute an access policy to manage access to the network by the client device associated with the subsequent network access request (612). In some examples, NAC system 180A may generate and send a notification to the administrator based on the implemented access policy (614). For instance, fingerprinting module 156 may generate and send a notification if fingerprinting module 156 implements an access policy to deny or quarantine a client device's access to the network. In some examples, the notification may include an indication of a severity level of the unauthorized client device's attempt to access the network.

In response to determining that the fingerprinting information of the client device associated with the subsequent network access request does not have an anomaly to previously obtained fingerprinting information of the authorized client device (“NO” of step 610), NAC system 180A may permit network access by the client device associated with the subsequent network access request (616).

The techniques described herein may be implemented in hardware, software, firmware, or any combination thereof. Various features described as modules, units or components may be implemented together in an integrated logic device or separately as discrete but interoperable logic devices or other hardware devices. In some cases, various features of electronic circuitry may be implemented as one or more integrated circuit devices, such as an integrated circuit chip or chipset.

If implemented in hardware, this disclosure may be directed to an apparatus such as a processor or an integrated circuit device, such as an integrated circuit chip or chipset. Alternatively, or additionally, if implemented in software or firmware, the techniques may be realized at least in part by a computer-readable data storage medium comprising instructions that, when executed, cause a processor to perform one or more of the methods described above. For example, the computer-readable data storage medium may store such instructions for execution by a processor.

A computer-readable medium may form part of a computer program product, which may include packaging materials. A computer-readable medium may comprise a computer data storage medium such as random-access memory (RAM), read-only memory (ROM), non-volatile random-access memory (NVRAM), electrically erasable programmable read-only memory (EEPROM), Flash memory, magnetic or optical data storage media, and the like. In some examples, an article of manufacture may comprise one or more computer-readable storage media.

In some examples, the computer-readable storage media may comprise non-transitory media. The term “non-transitory” may indicate that the storage medium is not embodied in a carrier wave or a propagated signal. In certain examples, a non-transitory storage medium may store data that can, over time, change (e.g., in RAM or cache).

The code or instructions may be software and/or firmware executed by processing circuitry including one or more processors, such as one or more digital signal processors (DSPs), general purpose microprocessors, application-specific integrated circuits (ASICs), field-programmable gate arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, functionality described in this disclosure may be provided within software modules or hardware modules.

What is claimed is:

1. A method comprising:
receiving a network access request for a client device to access a network;
obtaining fingerprinting information of the client device associated with the network access request, wherein the fingerprinting information comprises information specifying network behavior and location information of the client device associated with the network access request;
determining whether the client device associated with the network access request is a new client device requesting access to the network;
in response to determining that the client device associated with the network access request is not a new client device requesting access to the network, determining whether the fingerprinting information of the client device associated with the network access request has an anomaly to previously obtained fingerprinting information of an authorized client device, wherein the previously obtained fingerprinting information of the authorized client device comprises information specifying network behavior and location information of the authorized client device; and
executing, in response to determining that the fingerprinting information of the client device associated with the network access request has an anomaly to previously obtained fingerprinting information of the authorized client device, an access policy to manage access to the network by the client device associated with the network access request.

2. The method of claim 1, wherein the previously obtained fingerprinting information of the authorized client device comprises one or more of a Dynamic Host Configuration Protocol (DHCP) option, information included in a Link Layer Discovery Protocol (LLDP), information included in a Cisco™ Discovery Protocol (CDP), or a Hypertext Transfer Protocol (HTTP) user agent.

3. The method of claim 1, wherein obtaining fingerprinting information of the client device associated with the network access request comprises obtaining fingerprinting information of the client device associated with the network access request from one or more network access server (NAS) devices, wherein the one or more NAS devices comprise one or more of an access point device, a switch, or a router.

4. The method of claim 1,
wherein the authorized client device comprises a wired client device,
wherein the location information of the previously obtained fingerprinting information of the authorized client device comprises information identifying a port that connects a switch to the authorized client device, and
wherein determining whether the fingerprinting information of the client device associated with the network access request has an anomaly to previously obtained fingerprinting information of the authorized client device comprises determining whether information identifying a port that connects the switch to the client device associated with the network access request does not match the information identifying the port that connects the switch to the authorized client device.

5. The method of claim 1,
wherein the authorized client device comprises a wireless client device,
wherein the location information of the previously obtained fingerprinting information of the authorized client device comprises a geolocation of the authorized client device, and
wherein determining whether the fingerprinting information of the client device associated with the network access request has an anomaly to previously obtained fingerprinting information of the authorized client device comprises determining whether a geolocation of the client device associated with the network access request does not match the geolocation of the authorized client device.

6. The method of claim 5, wherein determining whether a geolocation of the client device associated with the network access request has an anomaly to the geolocation of the authorized client device comprises:
determining whether the geolocation of the client device associated with the network access request is within an expected geolocation of a mobility pattern of the authorized client device.

7. The method of claim 1, further comprising,
storing the previously obtained fingerprinting information of the authorized client device mapped to a Media Access Control (MAC) address of the authorized client device.

8. The method of claim 1, wherein determining that the client device associated with the network access request is not a new client device requesting access to the network comprises determining that a Media Access Control (MAC) address of the client device associated with the network access request matches a MAC address of the authorized client device.

9. The method of claim 1, further comprising:
in response to executing the access policy to manage access to the network by the client device associated with the network access request, sending, based on the access policy, a notification to an administrator.

10. A network access control (NAC) system, comprising:
a memory;
one or more processors in communication with the memory, the one or more processors configured to:
receive a network access request for a client device to access a network;
obtain fingerprinting information of the client device associated with the network access request, wherein the fingerprinting information comprises information specifying network behavior and location information of the client device associated with the network access request;
determine whether the client device associated with the network access request is a new client device requesting access to the network;
in response to determining the client device associated with the network access request is not a new client device requesting access to the network, determine whether the fingerprinting information of the client device associated with the network access request has an anomaly to previously obtained fingerprinting information of an authorized client device, wherein the previously obtained fingerprinting information of the authorized client device comprises information specifying network behavior and location information of the authorized client device; and
execute, in response to determining that the fingerprinting information of the client device associated with the network access request has an anomaly to previously obtained fingerprinting information of an authorized client device, an access policy to manage access to the network by the client device associated with the network access request.

11. The NAC system of claim 10, wherein the previously obtained fingerprinting information of the authorized client device comprises one or more of a Dynamic Host Configuration Protocol (DHCP) option, information included in a Link Layer Discovery Protocol (LLDP), information included in a Cisco™ Discovery Protocol (CDP), or a Hypertext Transfer Protocol (HTTP) user agent.

12. The NAC system of claim 10, wherein, to obtaining fingerprinting information of the client device associated with the network access request, the one or more processors are further configured to obtain fingerprinting information of the client device associated with the network access request from one or more network access server (NAS) devices, wherein the one or more NAS devices comprise one or more of an access point device, a switch, or a router.

13. The NAC system of claim 10,
wherein the authorized client device comprises a wired client device,
wherein the location information of the previously obtained fingerprinting information of the authorized client device comprises information identifying a port that connects a switch to the authorized client device, and
wherein to determine whether the fingerprinting information of the client device associated with the network access request has an anomaly to previously obtained fingerprinting information of the authorized client device, the one or more processors are further configured to determine whether information identifying a port that connects the switch to the client device associated with the network access request does not match the information identifying the port that connects the switch to the authorized client device.

14. The NAC system of claim 10,
wherein the authorized client device comprises a wireless client device,
wherein the location information of the previously obtained fingerprinting information of the authorized client device comprises a geolocation of the authorized client device, and
wherein to determine whether the fingerprinting information of the client device associated with the network access request has an anomaly to previously obtained fingerprinting information of the authorized client device, the one or more processors are further configured to determine whether a geolocation of the client device associated with the network access request does not match the geolocation of the authorized client device.

15. The NAC system of claim 14,
wherein, to determine whether a geolocation of the client device associated with the network access request does not match the geolocation of the authorized client device, the one or more processors are further configured to determine whether a geolocation of the client device associated with the network access request is within an expected geolocation of a mobility pattern of the authorized client device.

16. The NAC system of claim 10, wherein the one or more processors are further configured to:
store the previously obtained fingerprinting information of the authorized client device mapped to a Media Access Control (MAC) address of the authorized client device.

17. The NAC system of claim 10, wherein to determine that the client device associated with the network access request is not a new client device requesting access to the network, the one or more processors are further configured to determine a Media Access Control (MAC) address of the client device associated with the network access matches a MAC address of the authorized client device.

18. The NAC system of claim 10, wherein the one or more processors are further configured to:
in response to executing the access policy to manage access to the network by the client device associated with the network access request, send, based on the access policy, a notification to an administrator.

19. A non-transitory computer readable medium comprising instructions that when executed cause one or more processors to:
obtain fingerprinting information of the client device associated with the network access request, wherein the fingerprinting information comprises information specifying network behavior and location information of the client device associated with the network access request;
determine whether the client device associated with the network access request is a new client device requesting access to the network;
in response to determining the client device associated with the network access request is not a new client device requesting access to the network, determine whether the fingerprinting information of the client device associated with the network access request has an anomaly to previously obtained fingerprinting information of an authorized client device, wherein the previously fingerprinting information of the authorized client device comprises information specifying network behavior and location information of the authorized client device; and
execute, in response to determining that the fingerprinting information of the client device associated with the network access request has an anomaly to previously obtained fingerprinting information of an authorized client device, an access policy to manage access to the network by the client device associated with the network access request.
